(19) United States
(12) Patent Application Publication
(10) Pub. No.: US 2023/0011496 A1
(43) Pub. Date: Jan. 12, 2023

(54) ARTICULATED VEHICLE HYDRAULIC PITCH SYSTEM

(71) Applicant: ST ENGINEERING LAND SYSTEMS LTD, Singapore (SG)

(72) Inventor: Jiann Yi HO, Singapore (SG)

(21) Appl. No.: 17/782,271

(22) PCT Filed: Dec. 3, 2019
(86) PCT No.: PCT/SG2019/050594

§ 371 Date: Jun. 3, 2022

(51) Int. Cl. B62D 55/065

(52) U.S. Cl. CPC B62D 55/0655

(57) ABSTRACT

Embodiments include a pitch hydraulic system for a dual cabin articulated vehicle. The pitch hydraulic system includes an energy recovery function to harnesses hydraulic energy during vehicle mobility. A directional valve can be activated to allow movement of first and second pitch cylinders into either a “pitch up” or “pitch down” position. The pitch system can alter the stiffness of the unit to improve safety, stability and ride comfort.

### FIELD OF THE INVENTION

The present invention relates generally to a pitch hydraulic system for an articulated vehicle and more specifically to a pitch hydraulic system that recovers and harnesses hydraulic energy during vehicle mobility for enhancing performance of one or more hydraulic systems.

### BACKGROUND OF INVENTION

An articulated vehicle is a vehicle which has a permanent or semi-permanent pivot joint between cabins. Variation in the vertical displacement between the front and rear cabin portions during operation can be problematic. This can adversely affect the ride comfort and stability of the vehicle. This is especially the case when travelling over rough undulating terrain. Of course, external factors other than terrain, can also impact the vertical displacement of vehicles. For example, the detonation of a mine can induce movement of the vehicle cabin portions. As such, conventional systems and devices for articulated vehicles aim to control and reduce undesirable displacement, movement and pitch between articulated vehicle cabin portions to improve safety, stability and comfort.

WO2011037521 discloses an articulated vehicle in which the whole of the vehicle weight is utilized to reduce the impact on vehicle and personnel in the event of a detonation. A protective device utilises the weight of both the front and rear vehicle portion when the acceleration and/or speed of one of the vehicle portions exceeds a predetermined limit value, which happens when the vehicle is subjected to external influence, such as the detonation of a mine. When the relative position of each respective vehicle portion is fixed in relation to one another, the structure of the vehicle becomes stiffer, whereby the movement arising from the detonation is reduced and the impact upon personnel inside the vehicle is reduced.

CN102887177A discloses an obstacle surmounting type pitch device which adopts a hydraulic control system and comprises a pump, a reversing valve, a safety valve, an oil cylinder and an articulation device. The pitch device provides hydraulic fluid to the hydraulic system while the vehicle is running, whereby if a high/low wall obstacle is encountered, a change in pitch control cylinder can be made, and the vehicle body lifted by a certain angle to overcome obstacles.

To control and reduce undesirable displacement, movement and pitch between articulated vehicle portions, a pitch system can be advantageous in its efficient energy utilisation and regeneration. Conventional regenerative hydraulic circuits are typically designed for single chassis vehicles and do not account for the pitch and vertical displacement of a dual cabin articulated vehicle. Recent designs present some improvements.

For example, U.S. Pat. No. 9,340,954 B2 discloses an articulated work vehicle with a regenerative hydraulic circuit comprising a front and rear chassis. The circuit and hydraulic flow resistance of flow restrictors may be controlled such that articulation cycle time diminishes under low loads but increases under high loads. The regenerative hydraulic circuit may aid in the articulation of front and rear chassis to provide an articulation speed which is load dependent.

U.S. Pat. No. 10,273,658 B2 discloses a construction machine that has a control valve that supplies hydraulic fluid from a hydraulic pump to a hydraulic actuator. A regeneration circuit is provided for energy savings in which an accumulator stores either a holding pressure or a return pressure discharged from a hydraulic cylinder at the time of an operation of the hydraulic cylinder. The hydraulic pressure in the accumulator is used as a pilot pressure in a pilot control system.

While these publications describe some improvements, conventional pitch systems have limitations. For example, they do not quickly and precisely adjust for vertical displacement. Because of this, they are generally unsuited for the operation of an articulated vehicle over hills, rough or uneven terrain. As such, the present disclosure is aimed at providing a pitch system that overcomes, or at least ameliorates, one or more of the disadvantages described above in the context of an articulated vehicle with dual cabins. In particular, the present disclosure is aimed at providing a hydraulic pitch system that harnesses energy recovered from the pitch movement of a dual cabin vehicle to improve stability and ride comfort.

### BRIEF SUMMARY OF THE INVENTION

A primary object of the present invention is to provide a hydraulic pitch system for an articulated vehicle that will overcome or ameliorate the shortcomings of conventional pitch systems. In one aspect, the hydraulic pitch system disclosed herein can include an articulation unit connecting a front and rear cabin of the vehicle, a source of hydraulic fluid and a first pitch cylinder that has a bore chamber and a rod chamber. The first pitch cylinder can be mounted onto the articulation unit and connected to the front cabin. A second pitch cylinder can include a bore chamber and a rod chamber such that the second pitch cylinder is mounted onto the articulation unit and connected to the rear cabin. At least one directional valve can control the flow of the hydraulic fluid. At least one check valve can restrict the flow of the hydraulic fluid. An accumulator can store hydraulic fluid received from the first and second pitch cylinder and produce hydraulic energy. A pressure relief valve can set a pressure limit for the hydraulic fluid within the accumulator, wherein the first and second pitch cylinders are in fluid communication with the accumulator, and the check valve retains the hydraulic fluid in the accumulator until a pressure limit is reached. The hydraulic energy in the accumulator can modify the stiffness of the articulation unit.

In one aspect, the hydraulic pitch system can further comprise at least one load holding valve for controlling the movement of the first and second pitch cylinder.

In one aspect, the hydraulic pitch system can further comprise a shuttle valve for providing a load sense signal to a pump controller.

In one aspect, the hydraulic pitch system can further comprise a pressure transducer for measuring the pressure of the hydraulic fluid.

In one aspect, the hydraulic pitch system can further comprise a pitch system controller for setting the pressure limit of the pressure relief valve to a fixed parameter. In one aspect, the pitch system controller can be a rotary switch knob, selector switch or mode switch. In one aspect, the fixed parameter can have settings of high, medium and low.

In one aspect, the hydraulic energy generated can be additionally channelled to power other vehicle sub-systems.

In one aspect, the vehicle can be a track vehicle and the hydraulic energy can be additionally channelled to extend the vehicle track tension to stiffen a track system of the vehicle.

In one aspect, the at least one solenoid directional valve can comprise a first solenoid directional valve, a second solenoid directional valve, a third solenoid directional valve, a fourth solenoid directional valve and a fifth solenoid directional valve.

In one aspect, the at least one check valve can comprise a first check valve and a second check valve.

Another object is to provide a dual cabin articulated vehicle comprising the hydraulic pitch system disclosed herein. In one aspect, the vehicle can be a military track vehicle.

An additional object is to provide a method of operating the hydraulic pitch system disclosed herein, that includes steps of (1) activating or de-activating one or more of directional valves for controlling the extension and retraction of the first and second cylinders and flow of hydraulic fluid into the accumulator and (2) storing hydraulic fluid derived from the extension and retraction of the first and second cylinders in the accumulator to generate hydraulic energy.

In one aspect of the method, the at least one directional valve can be activated to allow movement of the first and second pitch cylinders into either a “pitch up” position, wherein the flow of hydraulic fluid can be directed from the pump to the bore chamber of the first and second cylinders for extension, wherein the hydraulic fluid from the rod chamber of the first and second cylinders can be channelled back to a reservoir, and wherein the fluid connection between the bore chamber and rod chamber of each cylinder and the accumulator can be cut off.

In another aspect of the method, the at least one directional valve can be activated to allow movement of the first and second pitch cylinders into a “pitch down” position, wherein the flow of hydraulic fluid can be directed from the pump to the rod chamber of the first and second cylinders for retraction, wherein the hydraulic fluid from the bore chamber of the first and second cylinders can be channelled back to a reservoir, wherein the fluid connection between the bore chamber and rod chamber of each cylinder and the accumulator can be cut off.

In one aspect of the method, the directional valve can be de-activated to enable the first and second pitch cylinders to freely extend and retract in response to the vehicle movement, wherein there can be a fluid connection between the bore chamber, rod chamber of each cylinder and the accumulator.

In one aspect, the method can further comprise recovering the hydraulic energy in the accumulator for modifying the stiffness of the articulation unit, wherein the directional valves can be activated to force hydraulic fluid into the accumulator from the first and second pitch cylinders, wherein a pressure limit of the hydraulic fluid in the accumulator can be set by the pressure relief valve.

Further objects of the invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### Definitions

The following words and terms used herein shall have the meaning indicated:

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The term “accumulator” refers to an energy storage device. The device can accept energy, store energy and release energy as needed. Specifically, a hydraulic accumulator is a pressure storage reservoir in which a non-compressible hydraulic fluid is held under pressure that is applied by an external source of mechanical energy.

The term “poppet valve” refers to a valve used to control the timing and quantity of liquid or vapor flow. The poppet valve is fundamentally different from slide and oscillating valves; instead of sliding or rocking over a seat to uncover a port, the poppet valve lifts from the seat with a movement perpendicular to the plane of the port.

The term “solenoid” or “solenoid valve” refers to an electromechanically operated valve. Its mechanism of operation can vary from linear action, plunger-type actuator to pivoted-armature actuators and rocker actuators. The valve can use a two-port design to regulate a flow or use a three or more port design to switch flows between ports. Multiple solenoid valves can be placed together on a manifold.

The term “steering unit” refers to a collection of components used to steer a vehicle. In a track vehicle, the steering unit varies the speeds of the left and right outputs for steering.

The term “upstream”, as used herein, refers to a relative position of a component in a hydraulic circuit that is closer to the hydraulic reservoir and flow created by the hydraulic pump in comparison to another component. The term “downstream”, as used herein, refers to a relative position of a component in a hydraulic circuit that is further along the circuit in the direction of fluid flow in comparison to another component.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

### BRIEF DESCRIPTION OF THE DRAWINGS

The summary above, as well as the following detailed description of illustrative embodiments, is better understood when read in conjunction with the appended drawings. For the purpose of illustrating the disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

FIG. 1 is a schematic diagram of the components of the hydraulic pitch system according to an embodiment.

FIG. 2 is a schematic diagram of the components of the hydraulic pitch system with a single solenoid directional valve according to an embodiment.

FIG. 3 depicts an articulated vehicle that can utilise the pitch hydraulic system according to an embodiment.

FIG. 4 depicts an articulated vehicle detailing the articulation unit that can utilise the pitch hydraulic system according to an embodiment

FIG. 5 depicts an articulated vehicle utilising the pitch hydraulic system in a “pitch down” mode according to an embodiment.

FIG. 6 depicts an articulated vehicle utilising the pitch hydraulic system in a “pitch up” mode according to an embodiment.

FIG. 7 is a schematic diagram depicting the hydraulic pitch system in “Pitch ON” mode according to an embodiment. Fluid flow from the pump to the cylinders is represented by the solid bold lines; and Fluid flow from the cylinders back to the reservoir is represented by dashed bold lines.

FIG. 8 is a schematic diagram depicting the hydraulic pitch system in “Pitch OFF” mode according to an embodiment. Fluid flow from the cylinders to the accumulator is represented by dashed bold lines; and Fluid flow from the pump is represented by the solid bold lines (i.e. blocked).

FIG. 9 is a schematic diagram depicting the hydraulic pitch system in “energy recovery” mode according to an embodiment. Fluid flow from the reservoir to the cylinder bore chamber is represented by dashed bold lines; Fluid flow from the cylinder rod chamber to the accumulator is represented by solid bold lines; Fluid flow from the pump is represented by the two dot and dash bold line (i.e. blocked).

### NUMERICAL REFERENCE FEATURES

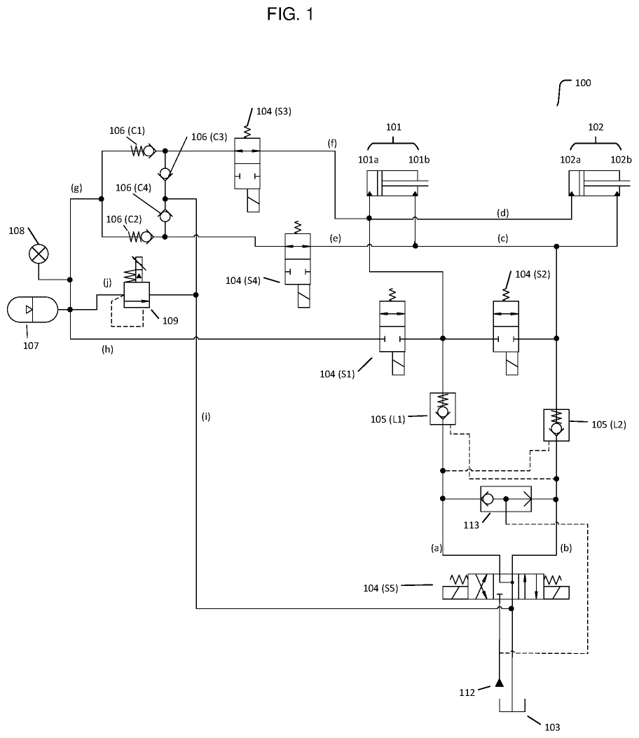

The following list of index numbers and associated features is intended for ease of reference to the FIG. 1 to 9 and illustrative embodiments of the present disclosure:
(100)—Pitch System
(101)—first hydraulic cylinder
(101a)—bore chamber
(101b)—rod chamber
(102)—second hydraulic cylinder
(102a)—bore chamber
(102b)—rod chamber
(103)—hydraulic reservoir
(104)—directional control valve (S1, S2, S3, S4, S5, S6)
(105)—Load holding valves (L1, L2)
(106)—check valves (C1, C2, C3, C4)
(107)—accumulator
(108)—pressure transducer
(109)—proportional electro-hydraulic relief valve
(112)—hydraulic pump
(113)—shuttle valve
(114)—articulation unit
(115)—pin joints
(a,b,c,d,e,f,g,h,i,j)—hydraulic flow path/lines

### DETAILED DESCRIPTION OF THE INVENTION

In a following description, reference is made to the accompanying drawings which form a part hereof, and in which is shown by way of illustration a specific example in which the invention may be practiced. It is to be understood that other embodiments may be utilized and structural changes may be made without departing from the scope of the present invention.

The present disclosure relates to a hydraulic pitch system for use in an articulated vehicle that may comprise two or more cabins or chassis. For example, in a double chassis or dual cabin vehicle, a second cabin trails the lead cabin and is connected via a pivot point (i.e. articulation unit) between the two cabins. In a track vehicle, the rear cabin can be steered by controlling the angle of the articulation unit rather than varying the speeds of right and left tracks. The direction of travel of the dual cabin track vehicle relies on the control of the yaw angle between the front and rear cabins. The yaw axis of rotation can be powered by an active (i.e. powered) actuator/articulation unit.

The hydraulic pitch system incorporates an energy recovery system that efficiently uses recovered energy to alter the stiffness of an articulation unit in the vehicle thereby improving safety, stability and ride comfort. However, it will be appreciated that other vehicle hydraulic sub-systems can also utilise the recovered energy for their operation.

The hydraulic pitch system disclosed herein operates using a collection of directional control valves, check valves, load holding valves, pressure relief valves in a hydraulic circuit connecting an accumulator and a pair of hydraulic cylinders mounted to the articulation unit. The hydraulic circuit can receive pressurized hydraulic fluid from a hydraulic pump that draws and returns fluid directly to a hydraulic reservoir.

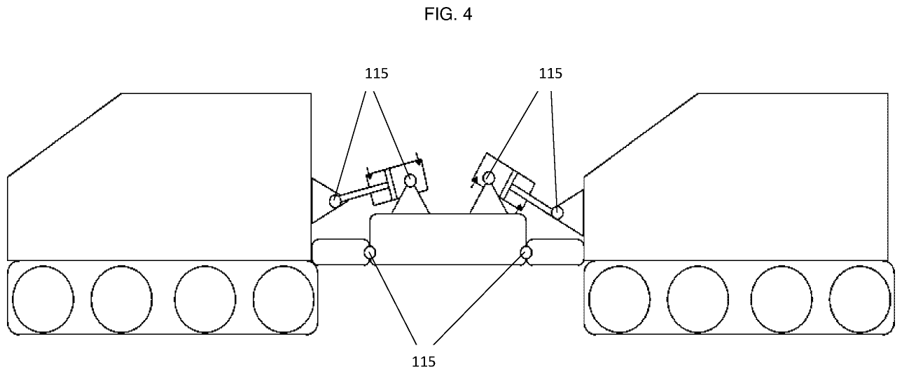

As will be appreciated by those skilled in the art, the articulation unit disclosed herein can be any mechanical structure connecting the front and rear cabin that allows the cabins to roll, yaw and pitch with respect to each other. In this respect, the articulation unit can include a pair of cylinders to actuate the pitch and the yaw movement, whereby these cylinders will be termed as pitch cylinders. Another pair of cylinders can be included in the articulation unit for a steering system of the vehicle, whereby these cylinders will be termed as steering cylinders. FIG. 4 illustrates the articulation unit and connection points with respect to the pair of pitch cylinders as well as the respective front and rear cabins, whereby pin joints (115) can allow rotation about the joints. Accordingly, the pair of pitch cylinders can be mounted to the articulation unit via pin joints and connected to the cabins of the vehicle via pin joints. It will be appreciated that other mounting or connections means known in the technical field other than pin joints may be used for achieving the same function with respect to the articulation unit.

The hydraulic pitch system disclosed herein provides the ability to utilise pressurized flow of hydraulic fluid from the pitch cylinders to generate and use hydraulic energy to modify the stiffness of the vehicle articulation unit. By increasing the stiffness of the vehicle articulation unit, the pitch system can reduce the amplitude of the vertical movement of the vehicle and improve the stability, ride comfort of the passengers. This is particularly beneficial during off-road driving or with rough or uneven terrain. In addition, the generated hydraulic energy can also be used to improve performance of various other vehicle hydraulic sub-systems. For example, the generated and recovered hydraulic energy can also be used to power hydraulic actuators such as track tensioner, optimise track tension in a track vehicle depending on the load that the vehicle is carrying or optimise a hydraulic actuated locking mechanism for doors or hatches.

The hydraulic pitch system disclosed herein can be used with various articulated vehicles such as those used for commercial, mining, construction or military applications. In one embodiment, the vehicle can be any dual cabin vehicle with an articulated unit. In a broader sense, the vehicle can include any vehicle towing a trailer or cabin that can be described as articulated, such as buses, trams, trains, tractors, diggers, cranes, trucks or military vehicles. In one embodiment, the vehicle can be an off-road vehicle. In one embodiment, the vehicle can be an off-road track vehicle. In particular, the pitch system can produce a pitch angle above 5° tilting up with respect to the planar surface the vehicle is travelling on which is particularly advantageous for off-road purposes. In another embodiment, the tilting up pitch angle can be at least 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29° or 30° with an upper limit being readily appreciated by the skilled artisan in the context of the technical field, for example an upper limit of 30°. In one embodiment, the pitch system can produce a pitch angle of at least 15° tilting up.

In one embodiment, the pitch system can produce a pitch angle above 5° tilting down with respect to the planar surface the vehicle is travelling on which is particularly advantageous for off-road purposes. In another embodiment, the tilting down pitch angle can be at least 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29° or 30° with an upper limit being readily appreciated by the skilled artisan in the context of the technical field, for example an upper limit of 35°. In one embodiment, the pitch system can produce a pitch angle of at least 20° tilting down.

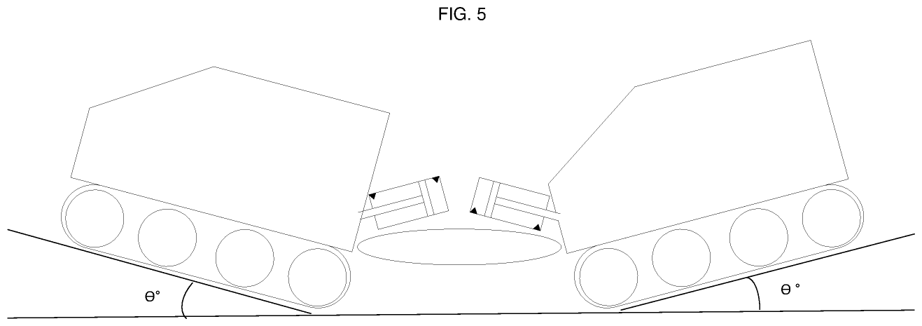

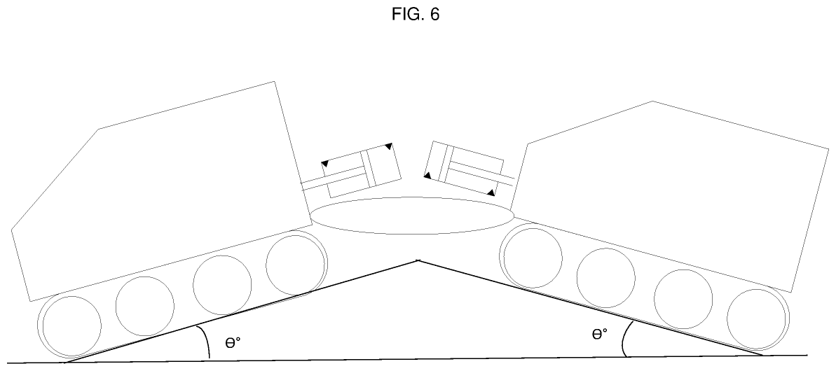

As shown in FIGS. 5 and 6 with respect to a two-cabin articulated vehicle, the pitch system disclosed herein can be designed to allow a pitch angle of 17° tilt up (FIG. 5) and/or a pitch angle of 25° tilt down (FIG. 6) to facilitate movement through complex terrain. The 17° tilt up of the front/rear cabin enables the vehicle to overcome higher vertical steps and the 25° tilt down of the front/rear cabins enable the vehicle to cross over a knife edge obstacle.

A “track vehicle” or “full-track vehicle” refers to a vehicle such as a tank that is supported, driven and steered by a tank/caterpillar tread. A track vehicle with a single chassis is steered by varying the speeds of the left and right tracks. An “articulated track vehicle” refers to a vehicle that has a permanent or semi-permanent pivot joint that is linked to a trailing vehicle. Steering is achieved by articulation of the two bodies about the pivot point.

In one embodiment, the vehicle can be a military vehicle that is engineered with an articulated body for rough terrain capability and can include tracks as opposed to wheels for steering. As such, the articulated vehicle disclosed herein can be a military track vehicle with a dual cabin.

In one embodiment, the articulated vehicle can be any vehicle with two or more cabins that includes an articulated unit connecting a cabin to a trailing cabin positioned behind a front cabin. In one embodiment, the articulated vehicle can be any dual cabin vehicle that includes an articulated unit that has a front cabin and rear cabin pivotally connected by an articulation unit. This arrangement enables the front cabin to move horizontally, vertically and laterally relative to rear cabin. It is appreciated that each cabin moves about a longitudinal, vertical and lateral axis, whereby movement about the longitudinal axis determines the roll of the cabin, movement about the vertical axis determines the yaw of the cabin and movement about the lateral axis determines the pitch of the cabin.

The vehicle described herein can be steered by such articulation and articulation unit connecting the cabins. For example, the heading of the vehicle will tend to move in the direction at which the front cabin is articulated relative to rear cabin when moving forward. This articulated configuration can provide all the steering capability necessary for the vehicle.

In one embodiment, the articulation unit pivotally connects the front cabin to rear cabin allowing both pivotal motion and the transfer of force between front cabin and rear cabin. This arrangement can allow the vehicle to steer left and right by articulating the front cabin with respect to rear cabin about the articulation unit. In one embodiment, the front cabin can be articulated relative to rear cabin about the articulation unit through the extension and retraction of a first hydraulic cylinder and a second hydraulic cylinder. Each of first hydraulic cylinder and second hydraulic cylinder can receive pressurized hydraulic fluid from a hydraulic fluid source. The hydraulic fluid source can be a hydraulic reservoir.

In one embodiment, the hydraulic pitch system can be adapted to a dual cabin vehicle with working equipment mounted on the rear cabin. In this embodiment, the recovered energy can be utilized to improve the stability of the rear cabin while the equipment mounted on the rear cabin is in operation. For example, in a military vehicle with a mortar system mounted onto a rear cabin, the accuracy of the mortar system can be improved through the pitch system enabling a more stable platform. Similarly, a crane system operating on a rear cabin of a construction vehicle will be subject to more steady, smooth ride as the platform is more stable.

The control and modification of the pitch of the vehicle through varying the stiffness of the articulation unit can have other advantages related to steering and manoeuvrability. For example, the pitch system can reduce the radius of the vehicles turning circle by modifying the pitch of the cabins during turning. It can also permit travel over uneven terrain. Specifically, when the pitch system disclosed herein is activated to tilt the front and rear cabin into a “V”-shape (See FIG. 5), the contact patch of the tracks will be reduced and will be nearer to the articulation unit which is the pivot point. This activation of the pitch system and “V”-shape arrangement can reduce the vehicle turning circle as compared with the whole track in contact with the ground when the pitch system is not activated.

The first hydraulic cylinder and second hydraulic cylinder can be described as linear hydraulic actuators that can extend or retract to modify the pitch angle of the cabins with respect to the articulation unit. The first hydraulic cylinder can be mounted onto the articulation unit connected to the front cabin. Similarly, the second hydraulic cylinder can be mounted onto the articulation unit connected to the rear cabin.

Each of the first hydraulic cylinder and second hydraulic cylinder can include a bore chamber located at a bore end and a rod chamber located at a rod end. The rod chamber can include a hollow cylindrical shell cavity with a fixed outer diameter, a fixed inner diameter that can be the diameter of a rod, and a length dependent upon extension or retraction of the cylinder. The bore chamber can include a hollow cylindrical cavity with a fixed diameter and a length dependent upon the extension or retraction of the cylinder. The rod chamber and the bore chamber can receive pressurized hydraulic fluid and force out pressurized hydraulic fluid through one or more ports.

The first hydraulic cylinder and second hydraulic cylinder can both be in fluid communication via a hydraulic circuit with an accumulator. The accumulator can be used for storing hydraulic fluid and producing hydraulic energy, essentially acting as a damper or energy storage device. In one embodiment, the hydraulic fluid can be retained and stored in the accumulator by one or more check valves and one or more directional control valves. The one or more directional control valves can be solenoid directional valves and/or poppet-type directional control valves. In one embodiment, the hydraulic fluid can be retained and stored in the accumulator by a pair of check valves and one or more solenoid directional control valves. The stored energy can be diverted on-demand to various hydraulic actuators or sub-systems in the vehicle using the hydraulic system for improved efficiency of their operation. These actuators or sub-systems can include the articulation unit, brake unit and suspension unit. The control of the flow of pressurized hydraulic fluid from the accumulator to the vehicle actuators or sub-systems can be controlled by a command from a computerized vehicle-control system or other conventional means to energised solenoid directional valve to switch the flow path.

In one embodiment, the accumulator can be a high, medium or low-pressure accumulator. The accumulator can be a diaphragm accumulator, bladder accumulator or piston accumulator, but is preferably a diaphragm accumulator. In one embodiment, the accumulator can be selected and sized to retain a desired amount of hydraulic fluid, such as 3.5 litres and up to 20 litres. In one embodiment, the accumulator can be sized to retain an amount of hydraulic fluid ranging from about 1 to 20 litres. However, the size of the accumulator can be scaled up or down to provide more or less energy storage depending on the hydraulic energy needed for the various actuators or sub-systems. As will be appreciated, the size of the accumulator can also be dependent on the vehicle and hydraulic system into which it will be incorporated. In one embodiment, the accumulator can be adapted to provide sufficient hydraulic energy to modify the stiffness of the articulation unit, whereby if the accumulator size is increased, the added capacity of hydraulic energy can be recovered and channeled to other vehicle sub-systems to power hydraulic actuators.

The pressure level in the accumulator can be regulated by a pressure relief valve. In one embodiment, the relief valve can be a proportional electro-hydraulic relief valve. The pressure relief valve can relieve the hydraulic fluid in the accumulator through a return circuit or feedback line when the pressure in the hydraulic system rises to or above a predetermined pressure limit. The relief valve can allow the venting of excess pressure and the return of hydraulic fluid to a hydraulic reservoir. As such, the pressure relief valve sets and limits the pressure in the system. The pressure limit setting can be determined by fixed parameters that may be termed as “low”, “medium” or “high”. The pressure limit and fixed parameters can be varied depending on the system requirements and vehicle.

The pressure limit setting and selection of a fixed parameter can be controlled or varied through a pitch system controller, for example, a rotary switch knob a selector switch or any variable control devices. Accordingly, in one embodiment, the system can include a pitch system controller for setting the pressure limit of the proportional electro-hydraulic relief valve to a fixed parameter. The pressure limit can range from 4,000 kPa to 21,000 kPa, whereby a “low” pressure limit can be in the range of about 4,000-6,000 kPa, a “Medium” pressure limit can be in the range of about 10,000-12,000 kPa, and a “High” pressure limit can be in the range of about 18,000-21,000 kPa.

In one embodiment, the pitch system disclosed herein can include a pressure transducer to measure the pressure of the hydraulic fluid in the system. In this regard, the pressure transducer may also be termed as a pressure transmitter, and in operation converts pressure measurement into an analogue electrical signal which can be used by sensing instrumentation such as microprocessors and computers. Most often, the operation of the pressure transducer is accomplished simply, via physical deformation or mechanical deflection. Pressure applied to the pressure transducer produces a deflection of the diaphragm which introduces strain to the gauges, whereby the strain will produce an electrical resistance change proportional to the pressure. In one embodiment, the pressure transducer can be a strain-gauge base transducer.

In the pitch system disclosed herein, the flow of hydraulic fluid from the hydraulic source to the first hydraulic cylinder, second hydraulic cylinder, accumulator and pressure relief valve can be through a hydraulic circuit that can include one or more of directional control valves, check valves, pressure relief valves, shuttle valves and/or load holding valves. The hydraulic source or reservoir can contain hydraulic fluid at atmospheric pressure or at a pressure above or below atmospheric pressure, depending on the vehicle type and the operational state of the hydraulic system. Conventionally hydraulic components, such as a hydraulic pump and valves can be hydraulically connected by hydraulic lines or hoses and fittings which provide substantially fluid-tight passages for hydraulic fluid.

In one embodiment, the pitch system can include at least one directional control valve. The directional control valves can be activated by any conventional means, preferably by electronic stimulation, for example by energizing a solenoid. Accordingly, the directional valves can be solenoid directional valves that direct the hydraulic fluid to a specific desired flow path depending on the energization of the solenoids. In one embodiment, the pitch system can comprise at least one solenoid directional valve. In one embodiment, the pitch system can comprise four, five or six solenoid directional valves. In one embodiment, the pitch system can comprise three solenoid directional valves (S1, S2, S6). In one embodiment, the pitch system can comprise four solenoid directional valves (S1, S2, S3, S4). In one embodiment, the pitch system can comprise five solenoid directional valves (S1, S2, S3, S4, S5). In one embodiment, one of the solenoid directional valves can be a 4/3 solenoid direction valve (S5) and the remaining four solenoid directional valves can be 2/2 direct solenoid operated directional spool valves (S1, S2, S3, S4). In one embodiment, one of the solenoid directional valves can be a 4/3 solenoid direction valve (S5) and the remaining three solenoid directional valves can be two 2/2 direct solenoid operated directional spool valves (S1, S2) and one 4/2 solenoid directional spool valve (S6).

In one embodiment, the pitch system can comprise at least one check valve. In one embodiment, the pitch system can comprise four check valves (C1, C2, C3, C4). The check valves function to stop the flow of hydraulic fluid in one direction and allow free flow in the opposite direction and essentially function in the pitch system to restrict the flow of hydraulic fluid in one direction. In one embodiment, the at least one check valve is for restricting the flow of the hydraulic fluid and more specifically to retain and store hydraulic fluid within the accumulator. In one embodiment, the pitch system can comprise two check valves (C1, C2) to allow fluid to flow through into the accumulator and prevent fluid from discharging through them in the reverse direction; and two check valves (C3, C4) to allow fluid from the reservoir to flow through to replenish fluid in the pitch cylinders and prevent formation of a vacuum when fluid is charged into the accumulator.

In one embodiment, the pitch system can comprise at least one load holding valve. In one embodiment, the pitch system can comprise two load holding valves (L1, L2). In one embodiment, the two load holding valves are directly hydraulically connected to one or both of the first and second cylinder. The load holding valve can control movement of the first and/or second cylinder in a desired position thereby limiting or preventing movement of said cylinders. In this regard, the load holding valve can hold the first and second cylinders in a desired final position to effectuate either a pitch up or pitch down position of the vehicle.

In one embodiment, the pitch system can comprise one shuttle valve (H). The shuttle valve can allow hydraulic fluid to flow through it from one of two sources and provides a load sense signal to a pump controller. In one embodiment, the pitch system can comprise at least one shuttle valve.

FIG. 1 depicts the components of the hydraulic pitch system (100) which can actuate the first hydraulic cylinder (101) and second hydraulic cylinder (102) to either extend or retract. A hydraulic pump (112) can draw hydraulic fluid from a hydraulic reservoir (103) to provide pressurized hydraulic fluid to a solenoid directional valve S5 (104). The solenoid direction valve S5 (104) can split the flow into two separate flows (a,b) via two lines to the first hydraulic cylinder (101) and second hydraulic cylinder (102). Each first and second flow (a,b) can be connected to a load holding valve L1, L2 (105). A shuttle valve (113) can be positioned upstream of the load holding valves (105) and connected to the first and second flow lines (a,b). The two flow lines (a,b) can be further split in to third and fourth flow paths and lines (c, d). The first hydraulic cylinder (101) and second hydraulic cylinder (102) can receive the hydraulic fluid from the first and third flow lines (a, d) at the bore chamber (101a, 102a) and receive the hydraulic fluid from the second and fourth flow lines (b, c) at the rod chamber (102a, 102b).

The first hydraulic cylinder (101) and second hydraulic cylinder (102) can direct hydraulic fluid to an accumulator (107) via a fifth and sixth flow (e,f) that intersect with one another downstream to form a single seventh flow path (g) that directs hydraulic fluid in to the accumulator (107) and/or back to the first and second flow (a,b) via an eighth flow line (h) with solenoid directional valves (S1, S2) controlling the flow to said first and second flow lines (a,b). The fifth and sixth flows (e,f) each include a solenoid directional valve S3, S4 (104) and a check valve C1, C2 (106), whereby these flows converge into the flow line (g) downstream of the check valve (106). Upstream of the check valve (106) a feedback line can intersect the fifth and sixth flows (e,f) and direct the hydraulic fluid back to the reservoir (103) via a check valve C3, C4 (106) and a ninth flow line (i). A pressure transducer (108) is connected to the flow line (g). A proportional electro-hydraulic relief valve (109) is connected to the accumulator (107) via a separate tenth flow line (j) that directs hydraulic fluid via the feedback line to the reservoir (103) via flow path (i).

Accordingly, in one embodiment, the hydraulic pitch system can be for a dual cabin articulated vehicle comprising: an articulation unit connecting a front and rear cabin of the vehicle; a source of hydraulic fluid; a first pitch cylinder comprising a bore chamber and a rod chamber, the first pitch cylinder being mounted onto the articulation unit and connected to the front cabin; a second pitch cylinder comprising a bore chamber and a rod chamber, the second pitch cylinder being mounted onto the articulation unit and connected to the rear cabin; at least one directional valve for controlling the flow path of the hydraulic fluid; at least one check valve for restricting the flow of the hydraulic fluid; an accumulator for storing hydraulic fluid received from the first and second pitch cylinder and producing hydraulic energy; and a pressure relief valve for setting a pressure limit of the hydraulic fluid within the accumulator, wherein the first and second pitch cylinders are in fluid communication with the accumulator, wherein the at least one check valve retains the hydraulic fluid in the accumulator until the set pressure limit, and wherein the hydraulic energy in the accumulator can be used to modify the stiffness of the articulation unit.

In another embodiment, the hydraulic pitch system can include at least one load holding valve for controlling the movement of the first and second pitch cylinder. In another embodiment, the hydraulic pitch system can include a shuttle valve for providing a load sense signal to a pump controller. In another embodiment, the hydraulic pitch system can include a pressure transducer for measuring the pressure of the hydraulic fluid. In another embodiment, the hydraulic pitch system can include a pitch system controller for setting the pressure limit of the pressure relief valve to a fixed parameter. In one embodiment, the pitch system controller can be a rotary switch knob, selector switch or mode switch. In one embodiment, the fixed parameter can be high, medium or low. In yet another embodiment, the hydraulic energy can be additionally channelled to power other vehicle sub-systems. In one embodiment, the at least one solenoid directional valve comprises, a first solenoid directional valve (S1), a second solenoid directional valve (S2), a third solenoid directional valve (S3), a fourth solenoid directional valve (S4) and a fifth solenoid directional valve (S5). In another embodiment, the at least one check valve can comprise a first check valve (C1), a second check valve (C2), a third check valve (C3), and a fourth check valve (C4).

In one embodiment, the vehicle can be a track vehicle and the hydraulic energy is additionally channelled to extend the vehicle track tension to stiffen a track system of the vehicle.

In one embodiment, there is provided a dual cabin articulated vehicle that can comprise the hydraulic pitch system disclosed herein. In one embodiment, the vehicle can be a military track vehicle.

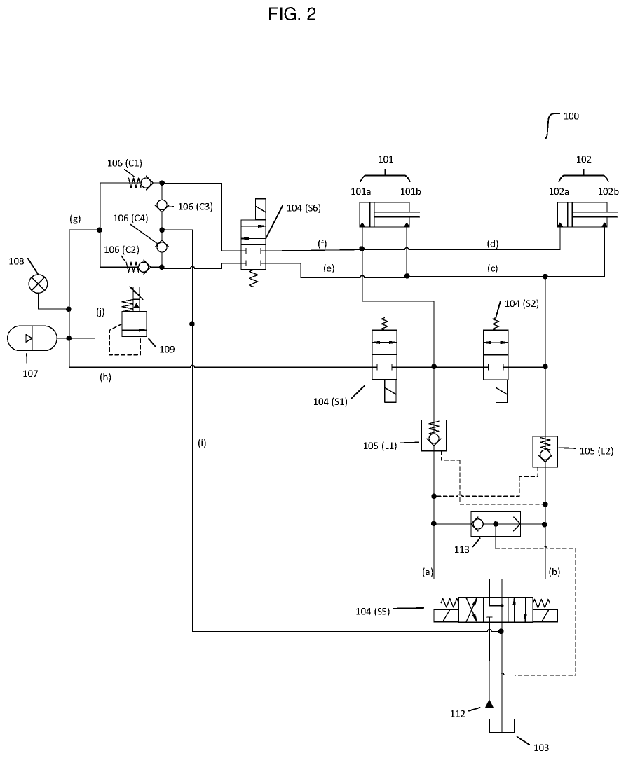

FIG. 2 illustrates an alternative embodiment to that in FIG. 1 with the exception that the fifth and sixth flow (e,f) are fed into a single solenoid directional valve S6 (104).

### Modes of Operation

The pitch system provides for pitch control that can be categorised based on different modes of operation. These modes of operation can be generally termed as “energy recovery”, “pitch on” and “pitch off” modes. The pitch system functions to control the motion of the pitch cylinders and allow hydraulic energy from any extension/retraction to be stored in an accumulator and harnessed during mobility of the vehicle. As will be appreciated, mobility of the vehicle through undulating terrain will cause the pitch cylinders to be subjected to forces causing them to extend and retract thereby generating hydraulic energy that the system stores to be harnessed for various ancillary purposes. By controlling the motion of the cylinders, the pitch system can control the movement and stiffness of the articulation unit.

The operation of the pitch system in the different modes of “energy recovery”, “pitch on” and “pitch off” can be controlled by a pitch system controller. The pitch system controller can be in the form of a mode switch, rotary knob or selector switch. In one embodiment, the pitch system controller can output signals to one or more of the directional valves and/or the pressure relief valve in order to control the actuation of the cylinders and flow path of the hydraulic fluid within the system.

In one embodiment, the pitch system controller can output signals to either energise or de-energise one or more solenoid directional valves. In one embodiment, the pitch system controller can output signals to the pressure relief valve to vary the pressure limit setting to a fixed parameter. The fixed parameters can include a “low”, “medium” or “high” pressure limit, whereby a high-pressure limit can result in the articulation unit being rigid. For example, through adjustment of the pitch system controller to increase the pressure limit setting of the pressure relief valve from 5,000 kPa to 15,000 kPa, the accumulator pressure can be increased to 15,000 kPa before the venting of excess pressure and returning hydraulic fluid to a hydraulic reservoir. At 15,000 kPa as opposed to 5,000 kPa, the cylinders become more rigid and a higher external force is required to extend or retract them. Consequently, the stiffness of the cylinders will effectively restrict or reduce the cylinder movement and translate into the stiffness of the articulation unit to reduce the amplitude of the vehicle cabin movement.

Accordingly, in one embodiment there is provided a method of operating the hydraulic pitch system comprising: activating or de-activating one or more of the at least one directional valve for controlling the extension and retraction of the first and second cylinders and flow of hydraulic fluid in to the accumulator; and storing hydraulic fluid derived from the extension and retraction of the first and second cylinders in the accumulator to generate hydraulic energy.

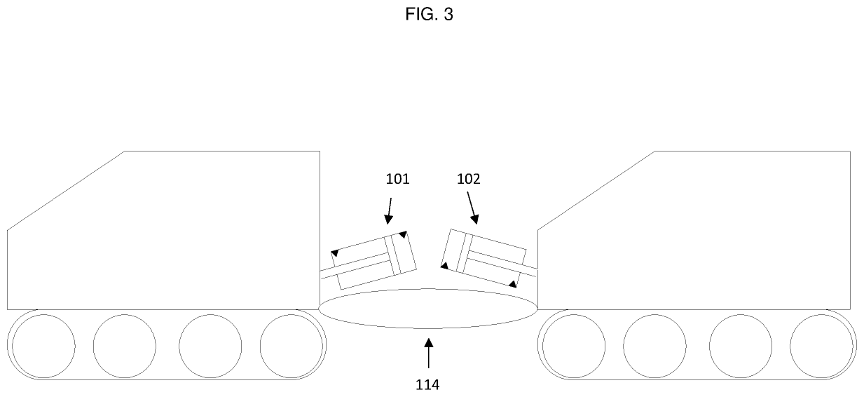

The operation of the different modes of “energy recovery”, “pitch on” and “pitch off” will be described below in the context of a dual cabin articulated vehicle that includes a pair of hydraulic cylinders mounted to an articulation unit, each connected to the front and rear cabin of the vehicle, as illustrated in FIG. 3 and utilising the pitch system as outlined in FIG. 1.

FIG. 3 depicts an articulated vehicle that can utilise the pitch hydraulic system according to an embodiment. The front cabin and rear cabin are joined by an articulation unit (114). The pitch system includes a pair of hydraulic cylinders (i.e. pitch cylinders) (101, 102) connecting the front and rear cabins. The articulation unit stays connected to the front and rear cabins as they roll, yaw and pitch with respect to each other.

### Pitch ON Mode

In “pitch on” mode, the pitch cylinders can be controlled to allow each of the cabins to pitch up or pitch down. FIG. 5 depicts an articulated vehicle utilising the pitch hydraulic system in a “pitch down” mode according to an embodiment. In this mode, the first and second cylinders can be controlled to allow the vehicle to pitch either upwards or downwards. Similarly, FIG. 6 depicts an articulated vehicle utilising the pitch hydraulic system in a “pitch up” mode according to an embodiment. The tilting down pitch angle θ° and tilting up pitch angle θ° are illustrated in FIGS. 5 and 6, respectively.

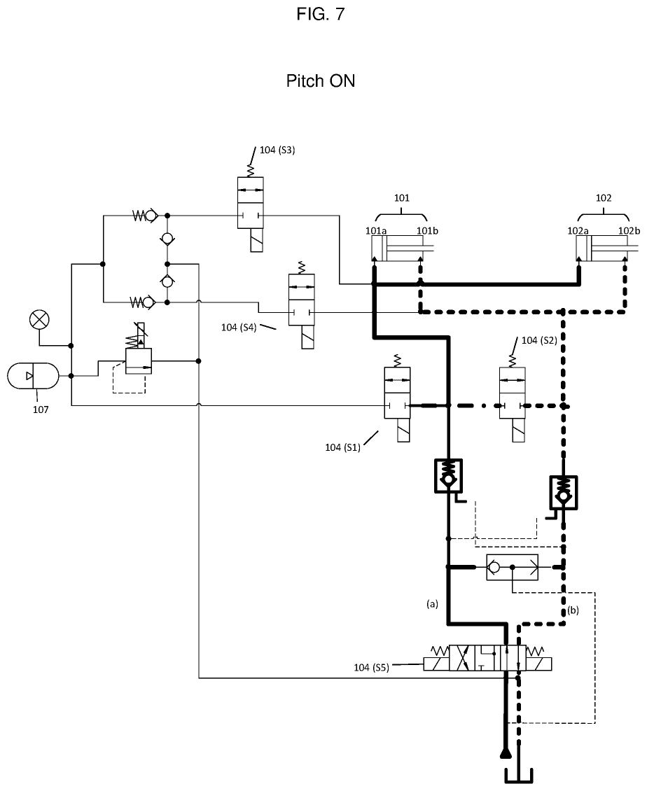

FIG. 7 is a schematic diagram depicting the hydraulic pitch system and components operating in “pitch on” mode. The pitch system controller can send electrical signals to energize solenoid directional valves. This allows hydraulic fluid to either extend or retract the first and second cylinders to either select if the pitch is “down” (FIG. 5) or “up” (FIG. 6). The position of the cylinders can be held in position by action of the load holding valves in the system.

Through energising the solenoid directional valves, the connection is cut off between the first and second cylinder bore and rod chambers, as well as with the accumulator.

Accordingly, in one embodiment of the method disclosed herein, the at least one directional valves are activated to allow movement of the first and second pitch cylinders into either a “pitch up” or “pitch down” position, wherein the fluid connection between the bore chamber and rod chamber of each cylinder and the accumulator (107) is cut off. In particular, in one embodiment of the method disclosed herein in the “pitch up” position, the flow of hydraulic fluid is directed from the pump to the bore chamber of the first and second cylinders for extension of the cylinders, and the hydraulic fluid from the rod chamber of the first and second cylinders is channelled back to a reservoir, wherein the fluid connection between the bore chamber and rod chamber of each cylinder and the accumulator is cut off. In the alternative embodiment of the method disclosed herein in the “pitch down” position, the at least one directional valve is activated or energised to allow the flow of hydraulic fluid to be directed from the pump to the rod chamber of the first and second cylinders for retraction of the cylinders, and the hydraulic fluid from the bore chamber of the first and second cylinders is channelled back to a reservoir, wherein the fluid connection between the bore chamber and rod chamber of each cylinder and the accumulator is cut off.

### Pitch ON Mode

Specifically, as illustrated in FIG. 7, when operating in “pitch on” mode, all the 2/2 solenoid valves (S1, S2, S3 and S4) are energised cutting off flow through them. A pitch “up” switch on a controller when toggled, energises the 4/3 solenoid valve (S5) to allow the flow from the pump to the bore chamber (101a, 102a) of the cylinders to extend the cylinders, represented by the bold solid lines in FIG. 7 along flow line (a). The fluid in the rod chamber (101b, 102b) of the cylinders will be forced out and channelled back to the reservoir, represented by the dashed bold lines in FIG. 7 along flow line (b). Contrarily, a pitch “down” switch on a controller when toggled, will switch over directional flow (a, b) of the fluid through the 4/3 solenoid valve (S5) to allow the flow from the pump to the rod chamber (101b, 102b) of the cylinders to retract the cylinders and fluid from the bore chamber (101a, 102a) of the cylinders will be forced out and channelled back to the reservoir.

### Pitch OFF Mode

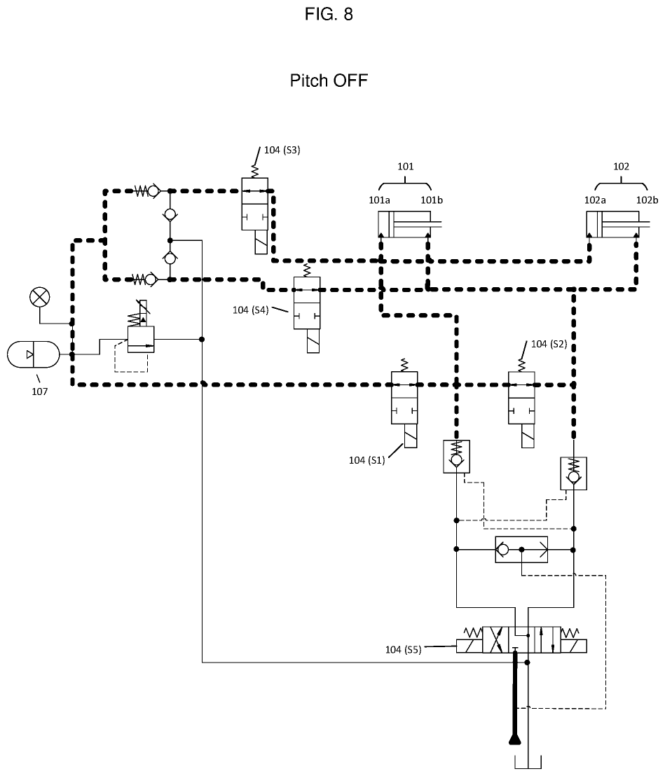

In “pitch off” mode, the pitch system is in its default state whereby all the solenoid directional valves (S1, S2, S3, S4, S5) are de-energised. The fluid flow from the pump is blocked at the valve S5 when this solenoid is de-energised and is in its neutral position. FIG. 8 is a schematic diagram depicting the hydraulic pitch system and components operating in “pitch off” mode. Accordingly, the first and second cylinder bore (101a, 102a) and rod chambers (101b, 102b), as well as with the accumulator (107) are fluidly connected to one another allowing the first and second cylinders (101, 102) to freely move according to the force translated from mobility of the terrain.

Accordingly, in one embodiment of the method disclosed herein the at least one directional valve can be de-activated to enable the first and second cylinders to freely extend and retract in response to the vehicle movement. Specifically, as illustrated in FIG. 8, when operating in this mode, all of the solenoid valves (S1, S2, S3, S4, S5) are de-energised and the lines connecting to the cylinders and accumulator are all hydraulically and fluidly connected. Fluid is free to flow through the system flow lines subject to the movement of the cylinders.

### Energy Recovery

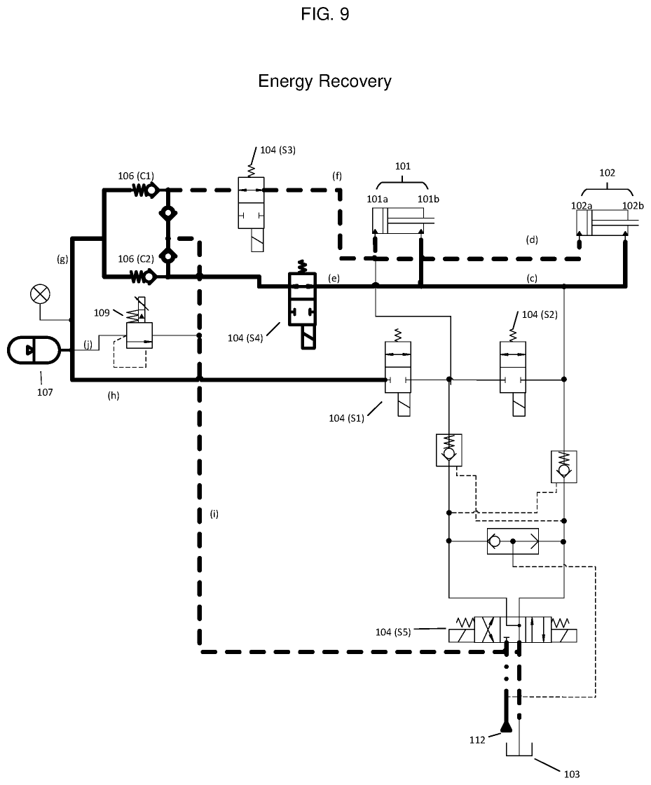

In “energy recovery” mode, energy can be recovered from the pitch system and utilised to alter the stiffness of the articulation unit and/or other hydraulic sub-systems in the vehicle. FIG. 9 is a schematic diagram depicting the hydraulic pitch system and components operating in “energy recovery” mode.

When the vehicle is driven across undulating terrain, the pitch cylinders will be subjected to external forces causing them to extend or retract. The movement of the pitch cylinders work like a pump to push hydraulic fluid from either the bore or rod chamber to the accumulator. Through energising solenoid directional valves S1 and S2 and de-energising solenoid directional valves S3 and S4, the hydraulic fluid from the cylinders is forced into the accumulator. For example, when the cylinder is forced to retract, the hydraulic fluid inside the bore chamber of the cylinders will be pushed through solenoid directional valve S3 and the check valve (C1) into the accumulator. Similarly, when the cylinder is forced to extend, the hydraulic fluid inside the rod chamber of the cylinders will be pushed through solenoid directional valve S4 and the check valve (C2) into the accumulator, as illustrated in FIG. 9.

The pitch system controller will send electrical signals to energise solenoid directional valves S1 and S2 to cut off the flow of hydraulic fluid along flow line (h) back to the cylinders (101, 102). This will force hydraulic fluid into the accumulator (107) as a result of any movement from the pitch cylinders. The hydraulic fluid will charge the accumulator up to the pressure limit set by the pressure relief valve (109). As illustrated in FIG. 9, when the cylinders are extending, the flow from the pump (112) is blocked by the 4/3 way directional valve (S5) and fluid from the rod chamber (101b, 102b) of the cylinders is forced through the 2/2 directional valve (S4) and the check valve (C2) into the accumulator (107), as represented by the solid lines in FIG. 9 along flow lines (c, e, g). Meanwhile, fluid is drawn from the reservoir (103) to fill the bore chamber (101a, 102a) of the cylinder to prevent formation of a vacuum, as represented by the dashed lines in FIG. 9 along flow lines (i, f, d). As will be appreciated, when the cylinders are retracting the flows between the bore and rod chambers to the accumulator and reservoir illustrated in FIG. 9 will be reversed.

Once the hydraulic fluid flows into the accumulator it is retained or trapped through activation of the check valves (C1, C2), thereby allowing the pressure in the accumulator to build up to the pressure limit setting of the relief valve.

The energy recovery mode of the pitch system allows for the recovered energy to be utilised to “stiffen up” the pitch system without having to draw energy from the vehicle. As will be appreciated, the accumulator can be up-sized to allow for more energy storage which can then be use to power hydraulic actuators in the rear vehicle module such as cylinders for operating the doors or locking mechanisms.

Accordingly, in one embodiment, the method disclosed herein can also include a step of recovering the hydraulic energy generated in the accumulator for modifying the stiffness of the articulation unit, wherein the at least one directional valves are activated to force hydraulic fluid in to the accumulator from the first and second pitch cylinders, and wherein a pressure limit of the hydraulic fluid in the accumulator is set by the pressure relief valve.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The foregoing has described the principles, embodiments and. modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

The invention has been described broadly and generically herein. Each of the narrower species and sub generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

What is claimed is:

1. A hydraulic pitch system for an articulated vehicle comprising two or more cabins, the system comprising:
an articulation unit connecting a front and rear cabin of the vehicle,
a source of hydraulic fluid,
a first pitch cylinder comprising a bore chamber and a rod chamber, the first pitch cylinder being mounted onto the articulation unit and connected to the front cabin,
a second pitch cylinder comprising a bore chamber and a rod chamber, the second pitch cylinder being mounted onto the articulation unit and connected to the rear cabin,
at least one directional valve for controlling one or more flow path of the hydraulic fluid,
at least one check valve for restricting the flow of the hydraulic fluid,
an accumulator for storing hydraulic fluid received from the extension and retraction of the first and second pitch cylinder and producing hydraulic energy, and
a pressure relief valve for setting a pressure limit of the hydraulic fluid within the accumulator,
wherein the first and second pitch cylinders are in fluid communication with the accumulator,
wherein the at least one check valve retains the hydraulic fluid in the accumulator until the set pressure limit, and
wherein the hydraulic energy in the accumulator modifies the stiffness of the articulation unit.

2. The hydraulic pitch system of claim 1, further comprising at least one load holding valve for controlling the movement of the first and second pitch cylinder.

3. The hydraulic pitch system of claim 1, further comprising a shuttle valve for providing a load sense signal to a pump controller.

4. The hydraulic pitch system of claim 1, further comprising a pressure transducer for measuring the pressure of the hydraulic fluid.

5. The hydraulic pitch system of claim 1, further comprising a pitch system controller for setting the pressure limit of the pressure relief valve to a fixed parameter.

6. The hydraulic pitch system of claim 5, wherein the pitch system controller is a rotary switch knob, selector switch or mode switch.

7. The hydraulic pitch system of claim 5, wherein the pitch system controller has fixed parameter settings of high, medium and low.

8. The hydraulic pitch system of claim 1, wherein the hydraulic energy is additionally channelled to power other vehicle sub-systems.

9. The hydraulic pitch system of claim 1, wherein the vehicle comprises tracks and the hydraulic energy is additionally channelled to extend track tension to stiffen the tracks of the vehicle.

10. The hydraulic pitch system of claim 1, wherein the at least one directional valve comprises, a first solenoid directional valve (S1), a second solenoid directional valve (S2), a third solenoid directional valve (S3), a fourth solenoid directional valve (S4) and a fifth solenoid directional valve (S5).

11. The hydraulic pitch system of claim 1, wherein the at least one check valve comprises a first check valve (C1) and a second check valve (C2).

12. A dual cabin articulated vehicle comprising the hydraulic pitch system of claim 1.

13. The vehicle of claim 12, wherein the vehicle is a military track vehicle.

14. A method of operating the hydraulic pitch system of claim 1, comprising steps of:
activating or de-activating one or more of the at least one directional valve for controlling the extension and retraction of the first and second pitch cylinders and flow of hydraulic fluid into the accumulator; and
storing hydraulic fluid derived from the extension and retraction of the first and second pitch cylinders in the accumulator to generate hydraulic energy.

15. The method of claim 14, wherein the at least one directional valve is activated to allow movement of the first and second pitch cylinders into a pitch up position,
wherein the flow of hydraulic fluid is directed from the pump to the bore chamber of the first and second pitch cylinders for extension,
wherein the hydraulic fluid from the rod chamber of the first and second pitch cylinders is channelled back to a reservoir, and
wherein the fluid connection between the bore chamber and rod chamber of each pitch cylinder and the accumulator is cut off.

16. The method of claim 14, wherein the at least one directional valve is activated to allow movement of the first and second pitch cylinders into a pitch down position,
wherein the flow of hydraulic fluid is directed from the pump to the rod chamber of the first and second cylinders for retraction, and
wherein the hydraulic fluid from the bore chamber of the first and second pitch cylinders is channelled back to a reservoir,
wherein the fluid connection between the bore chamber and rod chamber of each pitch cylinder and the accumulator is cut off.

17. The method of claim 14, wherein the at least one directional valve is de-activated to enable the first and second pitch cylinders to freely extend and retract in response to the vehicle movement,
wherein there is a fluid connection between the bore chamber, rod chamber of each pitch cylinder and the accumulator.

18. The method of claim 14, further comprising a step of recovering the hydraulic energy in the accumulator for modifying the stiffness of the articulation unit,
wherein the at least one directional valves are activated to force hydraulic fluid into the accumulator from the first and second pitch cylinders, and
wherein the flow of hydraulic fluid from the pump is blocked by at least one directional valve.
